(19) United States
(12) Patent Application Publication
(10) Pub. No.: US 2019/0276983 A1
(43) Pub. Date: Sep. 12, 2019

(54) METHOD AND SYSTEM FOR PROVIDING CUSTOMIZED BIOPROCESSING CONDITIONS FOR FEEDSTOCK

(71) Applicant: Tyton Biosciences, LLC, Danville, VA (US)

(72) Inventors: Iulian BOBE, Danville, VA (US); Florin G. BARLA, Danville, VA (US); Hsun-Cheng SU, Chapel Hill, NC (US); Conor Hartman, Durham, NC (US)

(21) Appl. No.: 16/424,899

(22) Filed: May 29, 2019

Related U.S. Application Data
(63) Continuation of application No. PCT/US17/65344, filed on Dec. 8, 2017.
(60) Provisional application No. 62/432,225, filed on Dec. 9, 2016.

(51) Int. Cl. D21C 3/22; D21C 3/02; B01J 19/00

(52) U.S. Cl. CPC D21C 3/228; B01J 2219/00243; B01J 19/0033; D21C 3/02

(57) ABSTRACT

The presently disclosed subject matter relates to a method and system of providing customized bioprocessing conditions for a variety of feedstock materials. Particularly, it has been surprisingly found that there is a correlation between the weight percent of lignin, cellulose, and/or hemicellulose and various reaction conditions. The weight percent lignin, cellulose, and hemicellulose are used to calculate indexes used to create a process index for sorting the feedstock into categories. A process adjustment factor can also be calculated and used to adjust the reaction conditions for each feedstock material.

### CROSS REFERENCE TO RELATED APPLICATIONS

This application is a continuation of PCT patent application no. PCT/US17/65344 filed on Dec. 8, 2017, which claims priority to and the benefit of U.S. Provisional Patent Application No. 62/432,225, filed Dec. 9, 2016, which is incorporated by reference herein in its entirety.

### TECHNICAL FIELD

The presently disclosed subject matter relates to a method and system for providing customized bioprocessing conditions for a variety of feedstock materials.

### BACKGROUND

There are many different types and categories of feedstock materials that can be processed to produce sugars, pulp, and the like. Particularly, feedstock materials can be composed of varying amounts of several components, such as lignin, cellulose, and hemicellulose. It has been shown that the difference in composition of the various components that make up the feedstock materials directly relates to the processing conditions. For example, feedstock materials that have a relatively high weight percentage of lignin may require longer residence time and/or higher temperatures to recover the maximum amount of sugars and/or pulp during processing. Therefore, it would be beneficial to provide customized bioprocessing conditions suitable for use with a wide variety of feedstock materials to streamline processing and optimize product recovery.

### SUMMARY

The presently disclosed subject matter is directed to a method of customizing reaction conditions for use in a subcritical water assisted hydrolysis reactor, based on a particular feedstock material, the method comprising: calculating the weight percent lignin (a), cellulose (b), and hemicellulose (c) in the feedstock material; calculating the lignin index (LI), cellulose index (CI), and hemicellulose index (HI) of the feedstock material according to the formulas LI=(a)/(1−a); CI=(b)/(1−b); HI=(c)/(1−c); calculating a Process Index (PI) for the feedstock material according to the formula PI=LI×100; sorting the feedstock material into categories based on the PI; and calculating a process adjustment factor (PAF) to adjust reaction parameters within each category according to the formula PAF=(LI/(CI+HI))×10. The PI and PAF are used to calculate reaction conditions for bioprocessing the feedstock material. In some embodiments, the reaction conditions are selected from temperature, pressure, reaction time, weight percent NaOH, or combinations thereof.

In some embodiments, the categories are set forth as follows: Category A=PI of 0-30; Category B=PI of 31-39; and Category C=PI≥40.

In some embodiments, the adjustment formulas for Category A feedstock are: 170+((Category A maximum temp.−Category A minimum temp.)/20)×feedstock PAF for temperature; 150+((Category A maximum psi−Category A minimum psi)/20)×feedstock PAF for pressure; 1+((Category A maximum NaOH %−Category A minimum NaOH %)/20)×feedstock PAF for weight percent NaOH; and 8+((Category A maximum reaction time−Category A minimum reaction time))/20)×feedstock PAF for reaction time.

In some embodiments, the adjustment formulas for Category B feedstock are: 185+((Category B maximum temp.−Category B minimum temp.)/20)×feedstock PAF for temperature; 250+((Category B maximum psi−Category B minimum psi)/20)×feedstock PAF for pressure; 2+((Category B maximum NaOH %−Category B minimum NaOH %)/20)×feedstock PAF for weight percent NaOH; and 18+((Category B maximum reaction time−Category B minimum reaction time))/20)×feedstock PAF for reaction time.

In some embodiments, the adjustment formulas for Category C feedstock are: 190+((Category C maximum temp.−Category C minimum temp.)/20)×feedstock PAF for temperature; 350+((Category C maximum psi−Category C minimum psi)/20)×feedstock PAF for pressure; 4+((Category C maximum NaOH %−Category C minimum NaOH %)/20)×feedstock PAF for weight percent NaOH; and 28+((Category C maximum reaction time−Category C minimum reaction time))/20)×feedstock PAF for reaction time.

In some embodiments, the presently disclosed subject matter is directed to the disclosed customized reaction conditions.

In some embodiments, the method further comprises processing the feedstock material according to the customized reaction conditions.

In some embodiments, the feedstock material is processed into pulp, sugar, cellulose, lignin, or combinations thereof.

In some embodiments, the feedstock material comprises biomass. In some embodiments, the biomass is selected from corn stover, wheat straw, rice straw, sugar cane bagasse, hemp, almond shells, peanut shells, tobacco stalks, switch grass, alfalfa, winter rye, woody crops, wood wastes, branches, pine needles, sawdust, paper and pulp industry residues or waste streams, wood fiber, or combinations thereof.

In some embodiments, the disclosed calculations are performed automatically using a computer.

In some embodiments, the presently disclosed subject matter is directed to a system for processing feedstock material, the system comprising: a reactor for processing feedstock material; and customized bioprocessing reaction conditions based on the feedstock material as set forth herein above.

In some embodiments, the reactor is selected from a horizontal reactor or a vertical reactor.

### DETAILED DESCRIPTION

The presently disclosed subject matter is introduced with sufficient details to provide an understanding of one or more particular embodiments of broader inventive subject matters. The descriptions expound upon and exemplify features of those embodiments without limiting the inventive subject matters to the explicitly described embodiments and features. Considerations in view of these descriptions will likely give rise to additional and similar embodiments and features without departing from the scope of the presently disclosed subject matter.

Unless defined otherwise, all technical and scientific terms used herein have the same meaning as commonly understood to one of ordinary skill in the art to which the presently disclosed subject matter pertains. Although any methods, devices, and materials similar or equivalent to those described herein can be used in the practice or testing of the presently disclosed subject matter, representative methods, devices, and materials are now described.

Following long-standing patent law convention, the terms “a”, “an”, and “the” refer to “one or more” when used in the subject specification, including the claims. Thus, for example, reference to “a reactor” can include a plurality of such reactors, and so forth.

Unless otherwise indicated, all numbers expressing quantities of components, conditions, and so forth used in the specification and claims are to be understood as being modified in all instances by the term “about”. Accordingly, unless indicated to the contrary, the numerical parameters set forth in the instant specification and attached claims are approximations that can vary depending upon the desired properties sought to be obtained by the presently disclosed subject matter.

As used herein, the term “about”, when referring to a value or to an amount of mass, weight, time, volume, concentration, and/or percentage can encompass variations of, in some embodiments +/−20%, in some embodiments +/−10%, in some embodiments +/−5%, in some embodiments +/−1%, in some embodiments +/−0.5%, and in some embodiments +/−0.1%, from the specified amount, as such variations are appropriate in the disclosed packages and methods.

The presently disclosed subject matter relates to a method and system for providing customized bioprocessing conditions via a subcritical water assisted hydrolysis system for a variety of feedstock materials. Particularly, it has been surprisingly found that there is a correlation between the weight percent of lignin, cellulose, and/or hemicellulose and various reaction conditions. The weight percentage of lignin, cellulose, and hemicellulose in (dry weight) feedstock can be calculated according to known methods.

The term “lignin” refers to a phenylpropane polymer of monolignol monomers found as an integral part of the secondary cell walls of plants and certain types of algae. The term “cellulose” refers to a homopolymer of β(1→4) linked D-glucose units that form a linear chain. The term “hemicellulose” refers to a heteropolymer that includes different saccharide units, such as (but not limited to) xylose, mannose, galactose, rhamnose, and/or arabinose, that form a branched polymer with several hundred to several thousand sugar units.

The feedstock lignin index, cellulose index, and hemicellulose index can then be calculated as follows:

Feedstock lignin % (dry weight)=a

Feedstock lignin index (“LI”)=a/(1−a)

Feedstock cellulose % (dry weight)=b

Feedstock cellulose index (“CI”)=b/(1−b)

Feedstock hemicellulose % (dry weight)=c

Feedstock hemicellulose index (“HI”)=c/(1−c)

Based on the LI, a sorting strategy can be created, referred to herein as the Process Index (“PI”). The PI=(LI)×100. It has been determined that each feedstock has a varied lignin/cellulose/hemicellulose ratio. Accordingly, a Process Adjustment Factor (“PAF”) was created to adjust the reaction parameter within each process category. For example, the following formula can be used to define the PAF range:

PAF=((LI/(CI+HI))×100.

The resulting subcritical water hydrolysis process categories can be divided into 3 categories based on the PI. Particularly, feedstock with a PI of 0-30 is sorted into Category A, feedstock with a PI of 31-39 is sorted into Category B; and feedstock with a PI of greater than or equal to 40 is sorted into Category C. Each category (A, B, or C) is associated with a particular set of processing conditions. For example, feedstock in category A can be processed at temperatures of about 170-190° C. at 150-300 psi, using a solvent comprising about 1-5% NaOH, with a reaction time of about 5-15 minutes. Representative processing conditions for each category is set forth in Table 1, below. However, it should be appreciated that in some embodiments the processing conditions can vary from those set forth in Table 1.

TABLE 1
Representative Processing Conditions

| Process | Temp | Pressure | NaOH | Reaction Time |
|---|---|---|---|---|
| Categories | (° C.) | (psi) | (%) | (minute) |
| A | 170-190 | 150-300 | 1-5 | 5-15 |
| B | 180-200 | 250-400 | 2-7 | 15-25 |
| C | 190-210 | 350-500 | 4-10 | 25-35 |

Therefore, each type of feedstock can be sorted into a category based on the PI to determine the optimal processing conditions to produce desired end products (such as pulp, with sugar and cellulose by-products).

Accordingly, the disclosed method can be used to predict and/or calculate the optimal processing conditions for a feedstock material, based on the PI and PAF. In some embodiments, the calculations can be done on a computing device, based on input from the user. For example, in some embodiments, the type of feedstock material is entered into a computing device to determine LI, CI, and HI (i.e., such as from a database). Suitable computing devices can include (but are not limited to) computers, smart phones, tablets, laptops, or any other device with internet capability. Alternatively, the weight percent lignin, cellulose, and hemicellulose can be measured and used to calculate LI, CI, and HI using methods known to those of ordinary skill in the art. The PI can then be automatically (i.e., by a computing device) or manually calculated to sort the feedstock material into the proper category (e.g., categories A, B, or C). The PAF can also be manually or automatically (i.e., by a computing device) calculated to adjust the reaction parameter within each process category. Thus, using the disclosed method, reaction conditions (temperature, pressure, % NaOH, and/or reaction time) for bioprocessing a wide variety of feedstock materials can be optimized for a wide variety of different feedstock materials. Bioprocessing conditions can then be executed to obtain the desired end products from the feedstock materials (e.g., pulp, with sugar, cellulose and lignin by-products in some embodiments).

In some embodiments, the presently disclosed subject matter is directed to a system comprising a reactor that can be used to process biomass. The system further comprises a set of instructions that correspond to the optimal processing conditions for the feedstock materials as set forth above. Thus, the system can include a set of customizable reaction conditions based on the particular feedstock used in the reactor. The reactor system is not limited and can include any type of bioprocessing reactor that can be used to process biomass into pulp, sugar, and/or cellulose. For example, in some embodiments, the reactor system can be a horizontal or vertical reactor system. In some embodiments, the system can comprise (in addition to the reactor) one or more processing modules (where the biomass is processed prior to entering the reactor), heating or cooling modules (to adjust the temperature of the biomass), and the like.

Any feedstock material known and used in the art can be used in accordance with the presently disclosed subject matter. For example, suitable feedstock material can include (but is not limited to) seeds, agricultural crop wastes and residues (such as corn stover, wheat straw, rice straw, sugar cane bagasse, hemp, almond shells, peanut shells, tobacco stalks, and the like), grass crops (such as switch grass, alfalfa, winter rye, and the like), woody crops, wood wastes, and residues (such as trees, softwood or hardwood forest thinnings, barky wastes, branches, pine needles, sawdust, paper and pulp industry residues or waste streams, wood fiber, and the like), food waste, and/or any organic materials. In some embodiments, the feedstock material can be fresh, partially dried, completely dried, or mixtures thereof (i.e., high moisture, low moisture, and all levels in between).

In some embodiments, the feedstock material can comprise biomass. The term “biomass” as used herein refers to biological material that can be used as fuel or for industrial production. Most commonly, biomass includes plant matter grown for use as biofuel, but it also can include plant or animal matter used for production of fibers, chemicals or heat. In some embodiments, biomass can include biodegradable wastes that can be used as fuel. According to the presently disclosed subject matter, biomass can be derived from a single source or can comprise a mixture derived from more than one source (such as a mixture of corn cobs and corn stover or a mixture of grass and leaves). Biomass includes, but is not limited to, bioenergy crops, tobacco plant, algal biomasses, agricultural residues, municipal solid waste, industrial solid waste, sludge from paper manufacture, yard waste, wood and forestry waste. Examples of biomass can further include (but are not limited to) microalgae, macroalgae, tobacco, tobacco seed, plant seed, corn grain, corn cobs, crop residues such as corn husks, corn stover, corn steep liquor, grasses, wheat, wheat straw, barley, barley straw, grain residue from barley degradation during brewing of beer, hay, rice straw, switchgrass, waste paper, sugar cane bagasse, sorghum, soy, components obtained from processing of grains, trees, branches, roots, leaves, wood chips, sawdust, shrubs and bushes, soybean hulls, vegetables, fruits, flowers and animal manure.

### EXAMPLES

The following Examples have been included to provide guidance to one of ordinary skill in the art for practicing representative embodiments of the presently disclosed subject matter. In light of the present disclosure and the general level of skill in the art, those of skill can appreciate that the following Examples are intended to be exemplary only and that numerous changes, modifications, and alterations can be employed without departing from the scope of the presently disclosed subject matter.

### Example 1

### Chemical Comparison of Various Feedstock Materials

The various weight percent of lignin (a), cellulose (b), and hemicellulose (c) were calculated using standard techniques. The results are given below in Table 2.

TABLE 2
Weight Percent Measurement of Various Feedstock Materials

| | Weight % | Weight % | Weight % |
|---|---|---|---|
| Feedstock Material | Lignin (a) | Cellulose (b) | Hemicellulose (c) |
| Soybean hulls | 2.0 | 46.0 | 18.0 |
| Peanut hulls | 35.2 | 22.1 | 12.1 |
| Pine wood (age 1-3 years) | 39.0 | 31.1 | 26.0 |
| Pine wood (age 21-25 | 30.4 | 42.5 | 22.9 |
| years) | | | |
| Pine wood (age >30 years) | 34.9 | 36.4 | 23.5 |
| Wine Pomace | 17.2 | 14.5 | 10.3 |
| Wine Pomace | 11.6 | 9.2 | 4.0 |
| Orange peel | 2.2 | 11.9 | 14.5 |
| Orange peel | 5.0 | 16.4 | 6.7 |
| Apple peel | 15.3 | 39.9 | 19.2 |
| Wheat straw | 14.1 | 38.6 | 32.6 |
| Corn stover | 15.0 | 38.5 | 28.0 |
| Corn cob | 14.6 | 43.2 | 31.8 |
| Tobacco Leaf | 4.5 | 18.5 | 17.0 |
| Tobacco Stalk | 19.0 | 32.0 | 22.0 |
| Hemp | 12.0 | 58.0 | 16.0 |
| Sugarcane bagasse | 22.0 | 35.0 | 25.0 |
| Bamboo | 25.3 | 47.2 | 23.9 |
| Forage sorghums | 16.3 | 34.0 | 18.2 |
| Switchgrass | 16.8 | 33.8 | 27.0 |
| Monterey pine | 25.9 | 41.7 | 20.5 |
| Eucalyptus saligna | 26.9 | 48.1 | 12.7 |
| Gmelina | 25.8 | 42.8 | 17.0 |
| Mango wood | 22.7 | 43.7 | 14.5 |
| Neem wood | 26.5 | 38.9 | 15.8 |
| Tropical almond wood | 27.8 | 41.8 | 9.8 |
| Rice straw | 13.0 | 32.0 | 25.5 |
| Barley straw | 16.5 | 38.0 | 32.5 |
| Sorghum straw | 13.0 | 32.0 | 24.0 |
| Sorghum stalks | 11.0 | 27.0 | 25.0 |
| Coconut coirs | 43.0 | 39.5 | 0.2 |
| Spruce | 29.0 | 43.6 | 27.4 |
| Spruce wood | 27.0 | 49.8 | 2.07 |
| Stone pine | 31.2 | 41.0 | 20.1 |
| Almond shell | 38.2 | 31.7 | 30.6 |
| Apricot stone | 51.4 | 22.4 | 20.8 |
| Cotton gin residue | 0.1 | 82.8 | 17.1 |
| Cotton seed hairs | 0.0 | 87.5 | 12.5 |
| Empty palm fruit bunches | 18.2 | 59.7 | 22.1 |
| Flax fibers | 2.5 | 56.5 | 15.4 |
| Flax bast fiber seed | 23.0 | 47.0 | 25.0 |
| Flax shives | 33.3 | 39.9 | 26.8 |
| Jatropha seed shell cake | 39.6 | 36.6 | 4.8 |
| Jute bast fibers | 23.5 | 49.0 | 19.5 |
| Kenaf bast fibers | 17.0 | 35.0 | 23.0 |
| Palm kernel shell | 20.4 | 30.6 | 30.6 |
| Tea residue | 40.0 | 30.2 | 19.9 |
| Millet husks | 14.0 | 33.3 | 26.9 |
| Olive husks | 50.4 | 25.0 | 24.6 |
| Risk husks | 24.6 | 43.8 | 31.6 |
| Legume straw | 34.0 | 28.1 | 34.1 |
| Oat straw | 16.6 | 31.6 | 49.6 |
| Oreganum stalks | 9.3 | 33.8 | 10.9 |
| Rape stalks | 17.0 | 40.0 | 14.0 |
| Rape straw | 18.0 | 54.8 | 23.2 |
| Rye straw | 17.5 | 28.5 | 32.5 |
| Sunflower stalks | 23.0 | 33.0 | 18.0 |
| Laurel extraction residues | 27.6 | 22.8 | 44.0 |
| Parthenium bagasse | 30.0 | 23.0 | 25.8 |
| Cashew nut shell | 40.1 | 41.3 | 18.6 |
| Cherry seed shells | 36.9 | 27.2 | 31.9 |
| Coconut shells | 28.7 | 36.3 | 25.1 |
| Hazelnut shells | 42.5 | 25.9 | 29.9 |
| Parinari fruit shell | 30.1 | 45.4 | 6.4 |
| Walnut shell | 52.3 | 25.6 | 22.7 |
| Cherry seed (kernel + shell) | 36.9 | 27.2 | 31.9 |
| Pomegranate seed | 39.7 | 26.9 | 25.5 |
| Safflower seed | 28.9 | 27.2 | 18.6 |
| Safflower seed cake | 26.7 | 40.0 | 16.0 |
| Banana waste | 14.0 | 13.2 | 14.8 |
| Tea waste | 40.0 | 30.2 | 19.9 |
| Eastern gamagrass | 20.4 | 37.0 | 22.1 |
| Elephant grass | 34.2 | 31.5 | 34.3 |
| Timothy grass | 28.9 | 38.0 | 33.1 |
| Cattle manure | 42.8 | 32.7 | 24.5 |
| Horse manure | 19.6 | 37.8 | 32.4 |
| Paper (newspaper) | 23.0 | 45.6 | 31.3 |
| Paper (waste pulps) | 8.6 | 74.3 | 17.1 |

### Example 2

### Feedstock Processing Groups and the Indication Index

For several different types of feedstock, the weight percent lignin (a), weight percent cellulose (b), and weight percent hemicellulose (c) were used to calculate lignin index (LI), cellulose index (CI), and hemicellulose index (HI). Particularly, for each feedstock, LI, CI and HI were calculated as follows: LI=a/(1−a); CI=b/(1−b); and HI=c/(1−c). The processing index (PI) was then calculated for each feedstock using the formula PI=LI×100. Because each feedstock can have a unique lignin/cellulose/hemicellulose ratio, a Process Adjustment Factor (PAF) was created to adjust reaction parameter within each category. PAF was calculated for each feedstock using the following formula: PAF=(LI/(CI+HI))×10. The results of these calculations are shown below in Tables 3 and 4.

TABLE 3
Feedstock Processing Groups

| Process | | | | |
|---|---|---|---|---|
| Method | | Lignin | Cellulose | Hemicellulose |
| Categories | Feedstocks | (a) % | (b) % | (c) % |
| A | Soybean Hulls | 2.0 | 46.0 | 18.0 |
| | Oreganum stalks | 9.3 | 33.8 | 10.9 |
| | Hemp | 12.0 | 58.0 | 16.0 |
| | Rice straw | 13.0 | 32.0 | 25.5 |
| | Sorghum straw | 13.0 | 32.0 | 24.0 |
| | Millet husks | 14.0 | 33.3 | 26.9 |
| | Wheat straw | 14.1 | 38.6 | 32.6 |
| | Corn stover | 15.0 | 38.5 | 28.0 |
| | Barley straw | 16.5 | 38.0 | 32.5 |
| | Oat straw | 16.6 | 31.6 | 49.6 |
| | Switchgrass | 16.8 | 33.8 | 27.0 |
| | Rape stalks | 17.0 | 40.0 | 14.0 |
| | Tobacco | 18.0 | 26.0 | 20.0 |
| | Rape straw | 18.0 | 54.8 | 23.2 |
| | Sugarcane bagasse | 22.0 | 35.0 | 25.0 |
| | Sunflower stalks | 23.0 | 33.0 | 18.0 |
| B | Jute bast fibers | 23.5 | 49.0 | 19.5 |
| | Rice husk | 24.6 | 43.8 | 31.6 |
| | Bamboo | 25.3 | 47.2 | 23.9 |
| | Neem wood | 26.5 | 38.9 | 15.8 |
| | Safflower seed cake | 26.7 | 40.0 | 16.0 |
| | Spruce wood | 27.0 | 49.8 | 20.7 |
| | Tropical almond wood | 27.8 | 41.8 | 9.8 |
| C | Coconut shells | 28.7 | 36.3 | 25.1 |
| | Peanut hulls | 35.2 | 22.1 | 12.1 |
| | Cherry seed shells | 36.9 | 27.2 | 31.9 |
| | Almond shell | 38.2 | 31.7 | 30.6 |
| | Pine wood | 39.0 | 31.1 | 26.0 |
| | Coconut coirs | 43.0 | 39.5 | 0.2 |
| | Walnut shell | 52.3 | 25.6 | 22.7 |

TABLE 4
Feedstock Processing Groups and Indication Index

| Process | | Lignin | | Hemi- | | Process |
|---|---|---|---|---|---|---|
| Method | | Index | Cellulose | cellulose | Processing | Adjustment |
| Categories | Feedstocks | (LI) | index (CI) | index (HI) | Index (PI) | Factor (PAF) |
| A | Soybean | 0.02 | 0.85 | 0.22 | 2 | 0 |
| | Hulls | | | | | |
| | Oreganum | 0.10 | 0.51 | 0.12 | 10 | 2 |
| | stalks | | | | | |
| | Hemp | 0.14 | 1.38 | 0.19 | 14 | 1 |
| | Rice straw | 0.15 | 0.47 | 0.34 | 15 | 2 |
| | Sorghum | 0.15 | 0.47 | 0.32 | 15 | 2 |
| | straw | | | | | |
| | Millet husks | 0.16 | 0.50 | 0.37 | 16 | 2 |
| | Wheat straw | 0.16 | 0.63 | 0.48 | 16 | 1 |
| | Corn stover | 0.18 | 0.63 | 0.39 | 18 | 2 |
| | Barley straw | 0.20 | 0.61 | 0.48 | 20 | 2 |
| | Oat straw | 0.20 | 0.46 | 0.87 | 20 | 1 |
| | Switchgrass | 0.20 | 0.51 | 0.37 | 20 | 2 |
| | Rape stalks | 0.20 | 0.67 | 0.16 | 20 | 2 |
| | Tobacco | 0.22 | 0.35 | 0.25 | 22 | 4 |
| | Rape straw | 0.22 | 1.21 | 0.30 | 22 | 1 |
| | Sugarcane | 0.28 | 0.54 | 0.33 | 28 | 3 |
| | bagasse | | | | | |
| | Sunflower | 0.30 | 0.49 | 0.22 | 30 | 4 |
| | stalks | | | | | |
| B | Jute bast | 0.31 | 0.96 | 0.24 | 31 | 3 |
| | fibers | | | | | |
| | Rice husk | 0.33 | .078 | 0.46 | 33 | 3 |
| | Bamboo | 0.34 | 0.89 | 0.31 | 34 | 3 |
| | Neem wood | 0.36 | 0.64 | 0.19 | 36 | 4 |
| | Safflower | 0.36 | 0.37 | 0.19 | 36 | 4 |
| | seed cake | | | | | |
| | Spruce wood | 0.37 | 0.99 | 0.26 | 37 | 3 |
| | Tropical | 0.38 | 0.72 | 0.11 | 38 | 5 |
| | almond wood | | | | | |
| C | Coconut | 0.40 | 0.57 | 0.34 | 40 | 4 |
| | shells | | | | | |
| | Peanut hulls | 0.54 | 0.28 | 0.14 | 54 | 13 |
| | Cherry seed | 0.58 | 0.37 | 0.47 | 58 | 7 |
| | shells | | | | | |
| | Almond shell | 0.62 | 0.46 | 0.0.44 | 62 | 7 |
| | Pine wood | 0.64 | 0.45 | 0.35 | 64 | 8 |
| | Coconut | 0.75 | 0.64 | 0.00 | 75 | 12 |
| | coirs | | | | | |
| | Walnut shell | 1.10 | 0.34 | 0.29 | 110 | 17 |

To obtain the adjusted reaction parameters, the temperature, pressure, NaOH and reaction time range of each process category was divided by 20, and multiplied by the PAF accordingly. The following formulas were applied for recommended reaction parameter setting:

### The Adjustment Formulas for Process Category A

170+((190−170)/20)×feedstock's PAF Temperature adjustment formula:

150+((300−150)/20)×feedstock's PAF Pressure adjustment formula:

1+((5−1)/20)×feedstock's PAF NaOH adjustment formula:

8+((15−5)/20)×feedstock's PAF Reaction time formula:

### The Adjustment Formulas for Process Category B

185+((200−180)/20)×feedstock's PAF Temperature adjustment formula:

250+((400−250)/20)×feedstock's PAF Pressure adjustment formula:

2+((7−2)/20)×feedstock's PAF NaOH adjustment formula:

18+((25−15)/20)×feedstock's PAF Reaction time formula:

### The Adjustment Formulas for Process Category C

190+((210−190)/20)×feedstock's PAF Temperature adjustment formula:

350+((500−350)/20)×feedstock's PAF Pressure adjustment formula:

4+((10−4)/20)×feedstock's PAF NaOH adjustment formula:

28+((35−25)/20)×feedstock's PAF Reaction time formula:

### Example 3

### Feedstock Processing Conditions Associated with Horizontal Reactor System

The estimated processing conditions for several feedstocks items was calculated with simulated Processing Index (PI) and Process Adjustment Factor (PAF) to estimate the reaction parameters of the horizontal reactor system. The results are shown below in Table 5.

TABLE 5
Estimated Processing Conditions for the
Various Simulated Feedstock Materials

| | Feed | | | | | | |
|---|---|---|---|---|---|---|---|
| Process | stock | | | | | | Reaction |
| Method | Item | | | Temp.* | Pressure* | NaOH | Time |
| Categories | Code | PI | PAF | (° C.) | (psi) | (%) | (min) |
| A | A001 | 12 | 1 | 171 | 158 | 1 | 9 |
| | A002 | 16 | 3 | 173 | 173 | 2 | 10 |
| | A003 | 20 | 4 | 174 | 190 | 2 | 10 |
| B | B001 | 32 | 4 | 189 | 280 | 3 | 20 |
| | B002 | 36 | 3 | 188 | 273 | 3 | 20 |
| | B003 | 39 | 5 | 190 | 288 | 3 | 21 |
| C | C001 | 45 | 11 | 201 | 433 | 7 | 34 |
| | C002 | 50 | 8 | 198 | 410 | 6 | 32 |
| | C003 | 65 | 13 | 203 | 448 | 8 | 35 |

*The value of temperature, pressure, % NaOH, and Reaction Time encompass variations of +/−5%.

What is claimed is:

1. A method of customizing reaction conditions for use in a reactor, based on a feedstock material, the method comprising:
a. calculating the weight percent lignin (a), cellulose (b), and hemicellulose (c) in the feedstock material;
b. calculating the lignin index (LI), cellulose index (CI), and hemicellulose index (HI) of the feedstock material according to the formulas LI=(a)/(1−a); CI=(b)/(1−b); HI=(c)/(1−c);
c. calculating Process Index (PI) for the feedstock material according to the formula PI=LI×100;
d. sorting the feedstock material into categories based on the PI;
e. calculating a process adjustment factor (PAF) to adjust reaction parameters within each category according to the formula PAF=(LI/(CI+HI))×10;
wherein the PI and PAF are used to calculate reaction conditions for bioprocessing the feedstock material; and
wherein the reaction conditions are temperature, pressure, reaction time, weight percent NaOH.

2. The method of claim 1, wherein the categories are set forth as follows:
a. Category A=PI of 0-30;
b. Category B=PI of 31-39; and
c. Category C=PI≥40.

3. The method of claim 2, further comprising adjustment formulas for Category A feedstock selected from:
a. 170+((Category A maximum temp.−Category A minimum temp.)/20)×feedstock PAF for temperature;
b. 150+((Category A maximum psi−Category A minimum psi)/20)×feedstock PAF for pressure;
c. 1+((Category A maximum NaOH %−Category A minimum NaOH %)/20)×feedstock PAF for weight percent NaOH;
d. 8+((Category A maximum reaction time−Category A minimum reaction time)/20)×feedstock PAF for reaction time; and
e. combinations thereof.

4. The method of claim 2, further comprising adjustment formulas for Category B feedstock selected from:
a. 185+((Category B maximum temp.−Category B minimum temp.)/20)×feedstock PAF for temperature;
b. 250+((Category B maximum psi−Category B minimum psi)/20)×feedstock PAF for pressure;
c. 2+((Category B maximum NaoH %−Category B minimum NaOH %)/20)×feedstock PAF for weight percent NaOH;
d. 8+((Category B maximum reaction time−Category B minimum reaction time)/20)×feedstock PAF for reaction time; and
e. combinations thereof.

5. The method of claim 2, further comprising adjustment formulas for Category C feedstock selected from:
a. 190+((Category C maximum temp.−Category C minimum temp.)/20)×feedstock PAF for temperature;
b. 350+((Category C maximum psi−Category C minimum psi)/20)×feedstock PAF for pressure;
c. 4+((Category C maximum NaOH %−Category C minimum NaOH %)/20)×feedstock PAF for weight percent NaOH;
d. 18+((Category C maximum reaction time−Category C minimum reaction time)/20)×feedstock PAF for reaction time; and
e. combinations thereof.

6. The customized reaction conditions of claim 1.

7. The method of claim 1, further comprising processing the feedstock material.

8. The method of claim 7, wherein the feedstock material is processed into pulp, sugar, cellulose, lignin, or combinations thereof.

9. The method of claim 1, wherein the feedstock material comprises biomass.

10. The method of claim 9, wherein the biomass comprises corn stover, wheat straw, rice straw, sugar cane bagasse, hemp, almond shells, peanut shells, tobacco stalks, switch grass, alfalfa, winter rye, woody crops, wood wastes, branches, pine needles, sawdust, paper and pulp industry residues or waste streams, wood fiber, or combinations thereof.

11. The method of claim 1, wherein the calculations are done automatically using a computing device.

12. A system for processing feedstock material, the system comprising:
a. a reactor for processing feedstock material;
b. customized bioprocessing reaction conditions based on the feedstock material;
wherein the reaction conditions are generated by:
calculating the weight percent lignin (a), cellulose (b), and hemicellulose (c) in the feedstock material;
calculating the lignin index (LI), cellulose index (CI), and hemicellulose index (HI) of the feedstock material according to the formulas LI=(a)/(1−a); CI=(b)/(1−b); HI=(c)/(1−c);
calculating Process Index (PI) for the feedstock material according to the formula PI=LI×100;
sorting the feedstock material into categories based on the PI; and
calculating a process adjustment factor (PAF) to adjust reaction parameters within each category according to the formula PAF=(LI/(CI+HI))×10;
wherein the PI and PAF are used to calculate reaction conditions for bioprocessing the feedstock material; and
wherein the reaction conditions are temperature, pressure, reaction time, weight percent NaOH.

13. The system of claim 12, wherein the reactor is selected from a horizontal reactor or a vertical reactor.

14. The system of claim 12, wherein the categories are set forth as follows:
a. Category A=PI of 0-30;
b. Category B=PI of 31-39; and
c. Category C=PI≥40.

15. The system of claim 14, further comprising adjustment formulas for Category A feedstock selected from:
a. 170+((Category A maximum temp.−Category A minimum temp.)/20)×feedstock PAF for temperature;
b. 150+((Category A maximum psi−Category A minimum psi)/20)×feedstock PAF for pressure;
c. 1+((Category A maximum NaOH %−Category A minimum NaOH %)/20)×feedstock PAF for weight percent NaOH;
d. 8+((Category A maximum reaction time−Category A minimum reaction time)/20)×feedstock PAF for reaction time; and
e. combinations thereof.

16. The system of claim 14, further comprising adjustment formulas for Category B feedstock selected from:
a. 185+((Category B maximum temp.−Category B minimum temp.)/20)×feedstock PAF for temperature;
b. 250+((Category B maximum psi−Category B minimum psi)/20)×feedstock PAF for pressure;
c. 2+((Category B maximum NaOH %−Category B minimum NaOH %)/20)×feedstock PAF for weight percent NaOH;
d. 8+((Category B maximum reaction time−Category B minimum reaction time)/20)×feedstock PAF for reaction time; and
e. combinations thereof.

17. The system of claim 14, further comprising adjustment formulas for Category C feedstock selected from:
a. 190+((Category C maximum temp.−Category C minimum temp.)/20)×feedstock PAF for temperature;
b. 350+((Category C maximum psi−Category C minimum psi)/20)×feedstock PAF for pressure;
c. 4+((Category C maximum NaOH %−Category C minimum NaOH %)/20)×feedstock PAF for weight percent NaOH;
d. 18+((Category C maximum reaction time−Category C minimum reaction time)/20)×feedstock PAF for reaction time; and
e. combinations thereof.

18. The system of claim 12, wherein the feedstock material is processed into pulp, sugar, cellulose, lignin, or combinations thereof.

19. The system of claim 12, wherein the feedstock material comprises biomass.

20. The system of claim 19, wherein the biomass comprises corn stover, wheat straw, rice straw, sugar cane bagasse, hemp, almond shells, peanut shells, tobacco stalks, switch grass, alfalfa, winter rye, woody crops, wood wastes, branches, pine needles, sawdust, paper and pulp industry residues or waste streams, wood fiber, or combinations thereof.
